(19) United States
(12) Patent Application Publication
(10) Pub. No.: US 2008/0224677 A1
(43) Pub. Date: Sep. 18, 2008

(54) DEAD TIME TRIMMING IN A CO-PACKAGE DEVICE

(75) Inventors: Kevin Kim, Cerritos, CA (US); Jason Zhang, Monterey Park, CA (US); Todd Vacca, Mission Viejo, CA (US)

Correspondence Address: OSTROLENK FABER GERB & SOFFEN, 1180 AVENUE OF THE AMERICAS, NEW YORK, NY, 100368403, US

(73) Assignee: INTERNATIONAL RECTIFIER CORPORATION, El Segundo, CA (US)

(21) Appl. No.: 12/047,796

(22) Filed: Mar. 13, 2008

Related U.S. Application Data
(60) Provisional application No. 60/906,740, filed on Mar. 13, 2007.

(51) Int. Cl. G05F 1/10

(52) U.S. Cl. 323/282

(57) ABSTRACT

A method of obtaining an optimized dead time for a synchronous switching power supply comprising a control IC and two series-connected switches, comprising packaging the control IC and the series-connected switches in a co-packaged module; providing a dead time delay circuit within the control IC circuit which has variable dead time; testing the switching power supply; varying the dead time in a defined sequence during the step of testing; monitoring a parameter during testing of the switching power supply as the dead time is varied; determining an optimal dead time based upon monitoring the parameter; and setting the dead time at the optimal dead time.

### CROSS-REFERENCE TO RELATED APPLICATIONS

This application is related to and claims the priority of U.S. Provisional Application Ser. No. 60/906,740 filed Mar. 13, 2007 and entitled Trimmable Dead Time in IPOWIR Module, the entire disclosure of which is incorporated by reference herein.

### BACKGROUND OF THE INVENTION

This application relates to switching power supplies.

In switching power supplies of the type including a control switch and a synchronous switch, the two switches are turned on in a complementary fashion such that neither switch is on at the same time. In order to prevent the two switches from being on at the same time near the switching times, a dead time is inserted to prevent a short circuit or shoot through condition. This dead time is shown in FIG. 2 with respect to a synchronous buck converter application shown in FIG. 1. The two switches, Q1 being the control switch and Q2 being the synchronous switch, are controlled by a PWM pulse train converted into two gate signals. There is a first dead time between the time the switch Q2 goes off and Q1 goes on (deadtime 1) and a second dead time between the time Q1 goes off and Q2 goes on (deadtime 2).

In these synchronous switching power supplies, the dead time has an important impact on the power supply efficiency. However, the optimal dead time changes from part to part and from each pair comprising the driver IC and the power switches. In discrete applications, the driver IC and the power switches are not sold in matching pairs, so it is very difficult to optimize the dead time in the IC without knowing which switches will be used until the system board is assembled.

### SUMMARY OF THE INVENTION

The invention solves this problem because all variations associated with power switches and layout become known at the time of production testing when the IC and the power switches are assembled together in a co-package of the IC and the power switches.

Post-package trimming of the two dead times can be achieved during production by monitoring power losses or gate signal delays at the testing stage.

Accordingly, the invention comprises co-packaging, into a single module, the control IC and the power switches and post-package trimming of the dead times in the control IC.

According to a preferred embodiment, the method of trimming can be by blowing fuses inside the control IC after stepping the dead time through to the optimal point by monitoring the power losses or gate signal delays.

Other features and advantages of the present invention will become apparent from the following description of the invention which refers to the accompanying drawings.

### BRIEF DESCRIPTION OF THE DRAWING(S)

The invention will now be described in greater detail in the following detailed description with reference to the drawings in which:

FIG. 1 shows a conventional synchronous buck switching converter;

FIG. 2 shows the PWM signal and the two gate signals for the control and synchronous switches, together with the dead times associated with the dead signals;

FIG. 3 shows a co-packaged switching converter comprising the control IC and the two switches in a synchronous buck converter employing dead time trimming according to the present invention; and

FIG. 4 shows a block diagram of the control IC of the switching converter including the trimmable dead time and pulse generation circuit.

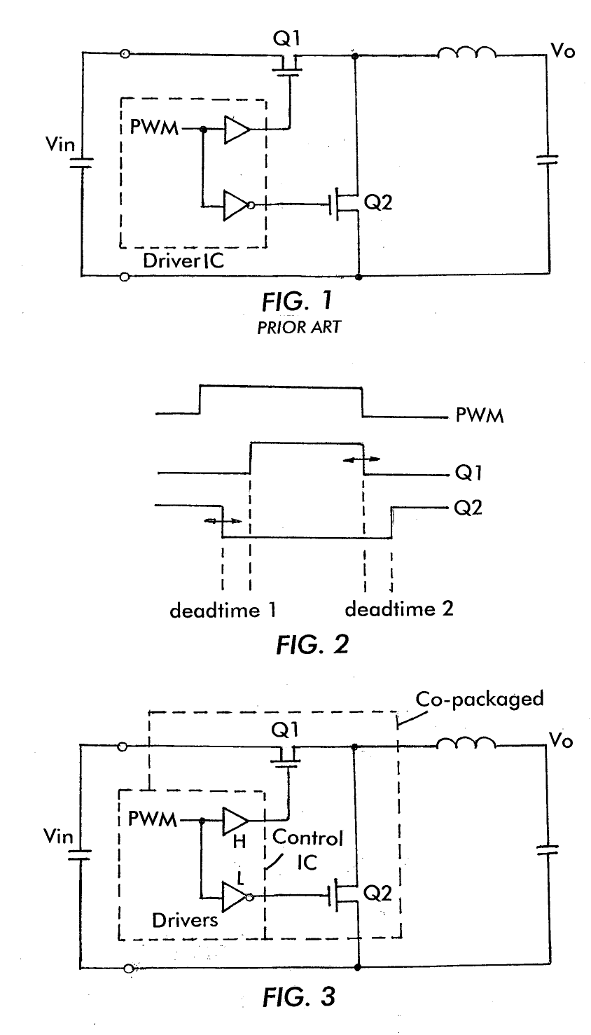

### DETAILED DESCRIPTION OF PREFERRED EMBODIMENTS OF THE INVENTION

With reference now to FIG. 3, a synchronous buck converter is shown. This synchronous buck converter employs two switches Q1 and Q2. Q1 is the control switch and Q2 is the synchronous switch. A control IC produces a PWM signal which is provided to two drivers H and L driving the gates of the switches Q1 and Q2. The drivers produce complementary signals such that when the gate of Q1 is turned on, Q2 is off and vice versa. In addition, the control IC provides a dead time between the on-times of the gate signals driving the switches Q1 and Q2, as shown in FIG. 2.

According to the invention, the switches Q1, Q2 and the control IC are co-packaged in a single module. The control IC incorporates dead time trimming stages that determine the amount of dead time. Because the control IC and switches are co-packaged, all variations associated with the switches and layout are known at the time of production testing. By monitoring the power losses or gate signal delays during production testing, while the dead times are varied in the driver control IC, the optimal dead time for both dead time 1 and dead time 2 can be determined. This optimal dead time is determined by post-package trimming, i.e., trimming after the package is assembled. This concept can also be applied to wafer level trimming if the switch and package characteristics are well determined.

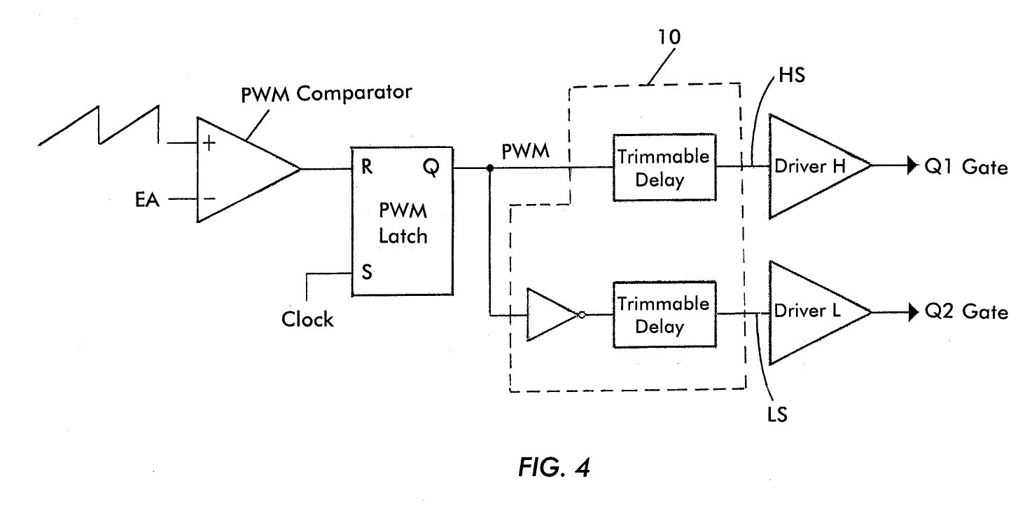

FIG. 4 shows the block diagram of a typical control IC which has an error amplifier signal EA generated by monitoring an output of the converter and producing an error signal. The error signal EA is typically compared to a reference waveform, e.g., a ramp signal, by a PWM comparator that produces a PWM signal. The PWM signal is typically synchronized to a clock signal by a PWM latch. The output PWM signal of the latch is then provided to a dead time and pulse generator circuit/level shifting circuit 10, as well known, to provide two pulse trains, one for the high side (control) switch Q1 and one for the low side (synchronous) switch Q2. The circuit 10 includes provision for incrementing the dead times using a suitable program at the test stage.

Preferably, the method of trimming is to blow fuses inside the control IC after stepping it through a sequence of dead times until the optimal dead time is attained. The blowing of fuses is a well-known technique for optimizing circuit operation.

Although the present invention has been described in relation to particular embodiments thereof, many other variations and modifications and other uses will become apparent to those skilled in the art. Therefore the present invention should be limited not by the specific disclosure herein, but only by the appended claims.

What is claimed is:

1. A method of obtaining an optimized dead time for a synchronous switching power supply comprising a control IC and two series-connected switches, comprising:
packaging the control IC and the series-connected switches in a co-packaged module;
providing a dead time delay circuit within the control IC circuit which has variable dead time;
testing the switching power supply;
varying the dead time in a defined sequence during the step of testing;
monitoring a parameter during testing of the switching power supply as the dead time is varied;
determining an optimal dead time based upon monitoring the parameter; and
setting the dead time at the optimal dead time.

2. The method of claim 1, wherein the step of monitoring comprises monitoring power losses or gate signal delays of at least one of the switches.

3. The method of claim 1, wherein the step of varying the dead time comprises stepping the dead time in the control IC through a plurality of dead times until the optimal dead time is attained and the step of setting the dead time at the optimal dead time comprises blowing fuses inside the control IC to attain the optimal dead time.
